(19) United States
(12) Patent Application Publication
(10) Pub. No.: US 2015/0143739 A1
(43) Pub. Date: May 28, 2015

(54) ATTACHMENT APPARATUS

(71) Applicants: Norman Wells, Solvang, CA (US); Diane Norman, Solvang, CA (US)

(72) Inventors: Norman Wells, Solvang, CA (US); Diane Norman, Solvang, CA (US)

(21) Appl. No.: 14/092,052

(22) Filed: Nov. 27, 2013

(51) Int. Cl. A01K 91/047

(52) U.S. Cl. CPC A01K 91/047
USPC 43/44.98; 29/505

(57) ABSTRACT

An attachment apparatus which connects a first object to a second object. The attachment apparatus has a loop which allows the user to thread a second object through. The first object is held in place by the use of a barrier at the opposite end of the loop. The attachment apparatus may be used with fishing sinker weights and fishing lines.

### CROSS-REFERENCE TO RELATED APPLICATION

This Non-Provisional Patent Application claims priority to pending Design U.S. Application Ser. No. 29/446,642, filed on Feb. 26, 2013, incorporated herein by reference in its entirety and claims priority thereto.

### FIELD OF THE INVENTION

The present invention relates to fishing sinker weight holders, and more particularly to a new form of fishing sinker weight holders which are intended for use in fishing but also as a method of attaching other devices.

### BACKGROUND OF THE INVENTION

Fishers use sinker weights to weigh down fishing lines. The process would require the user to find the appropriate weight and then tie them to the fishing line. However, the problem would arise when changing out the weights. This would require the user to retrieve the fishing line then to either untie the fishing line or cut them to release the fishing weights. Then, the user would have to experiment with additional weights or the subtraction of weights in order get the right balance. However, as noted previously, this would require the user to retrieve the line back and then untie or cut the line in order to get the right balance.

In addition, a user may desire to attach a first object to a second object. This could be accomplished by tying one object to another. However, like the problem with changing fishing weights, the user would have either untie the line or cut the line in order to release the object from each other.

There exists a need for an inexpensive way to attach fishing weights to the fishing line. Also, there exists a need to attach a first object to a second object without the associated problems.

### SUMMARY OF THE INVENTION

The present invention addresses the above stated need by providing an inexpensive, attachment apparatus which provides a user to attach fishing weights to a fishing line. The attachment apparatus includes a loop, a longitudinal body, and a barrier. The fishing line is threaded through the loop. The fishing weights are slid onto the longitudinal body once the barrier is deformed. Once the weights are slid along the longitudinal body, the barrier is released to assume its natural position whereby acting as a barrier that prevents the fishing weights from falling off.

It is an object of the invention to provide an inexpensive, device that attaches a first object to a second object. The device may attach keys to a bag or purse. Moreover, the apparatus may be used to lock itself and in the process holding objects. This process can be used to decorate the user's wrist once beads have been placed along the longitudinal body.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of an attachment apparatus according to at least one aspect of the invention.

FIG. 2 is a front view of FIG. 1 with the tabs of the barrier in deformed form.

FIG. 3 is a front view of FIG. 1 where a non-continuous ring is attached to a loop with an example of other items that may be attached to the non-continuous ring along with other items that may be attached to the attachment apparatus.

FIG. 4 is a front view of FIG. 1 with a line threaded through the loop concurrently with a non-continuous ring attached to the loop.

### DETAILED DESCRIPTION

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

Reference will now be made in detail to various exemplary embodiments of the invention. The following detailed description is presented for the purpose of describing certain embodiments in detail. The present invention may be further illustrated in the following figures, attention being called to the fact, however, that the embodiments described in the description and shown in the figures are illustrative only and are not intended to limit the scope of the invention, and that changes may be made in the specific constructions described in this specification and accompanying drawings that a person of ordinary skill in the art will recognize are within the scope and spirit of the invention. The true scope of the invention is defined by the claims. Further, any features of any embodiment described herein are equally applicable to any other embodiment described herein or envisioned by one of ordinary skill in the art. The detailed description and figures provided herein should not be construed to exclude features otherwise described with respect to another embodiment.

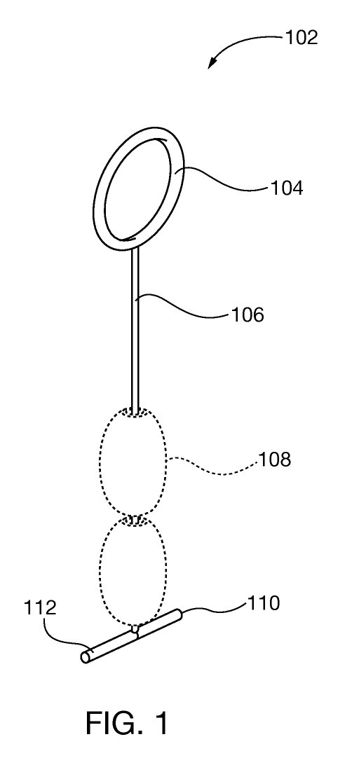

Referring now to FIG. 1, an attachment apparatus 102 is depicted. The apparatus 102 may include a loop 104, a barrier 110, 112, and a longitudinal body 106. The different elements and components of the attachment apparatus 102 may attach a first object with a second object such as a line and fishing weights 108, a line and keys, or a key ring with keys, and other similar connections. The use of the words “attachment apparatus” 102 may be interchanged with the words “attachment device.”

The attachment apparatus 102 is used to connect a first object to a second object. As a non-limiting example, the attachment apparatus 102 may be used to in the activity of fishing. More specifically, the attachment apparatus 102 may be used to connect a fishing line to fishing weights 108. Traditionally, fishing weights are tied to the fishing line. As such it takes a certain amount of time to tie the fishing weights to the line. Also, another problem arises when switching the fishing weights where it would require the user to untie or cut the fishing line to release the fishing line. The attachment apparatus 102 allows the user to slide the fishing weights 108 along the longitudinal body 106. As a non-limiting example, the longitudinal body 106 may be made up of polyurethane, nylon, plastic, or any other material. The longitudinal body 106 has a first end and a second end. A loop 104 is attached to the first end. At the far end of the longitudinal body 106 from the loop 104, is where a barrier 110 and 112 is attached to the second end. The barriers 110 and 112 are deformable from a first position to a second position. As a non-limiting example, the barriers 110 and 112 may be made up of polyurethane, nylon, plastic, or any other material. The first position may be horizontal to the vertical longitudinal body 106. The barriers 110 and 112 may consist of protruding tabs and in its first position; the barriers 110 and 112 would prevent the weights 108 from falling off. The first position is the natural state where the aforementioned tabs would be erect and holds the weights 108 in place.

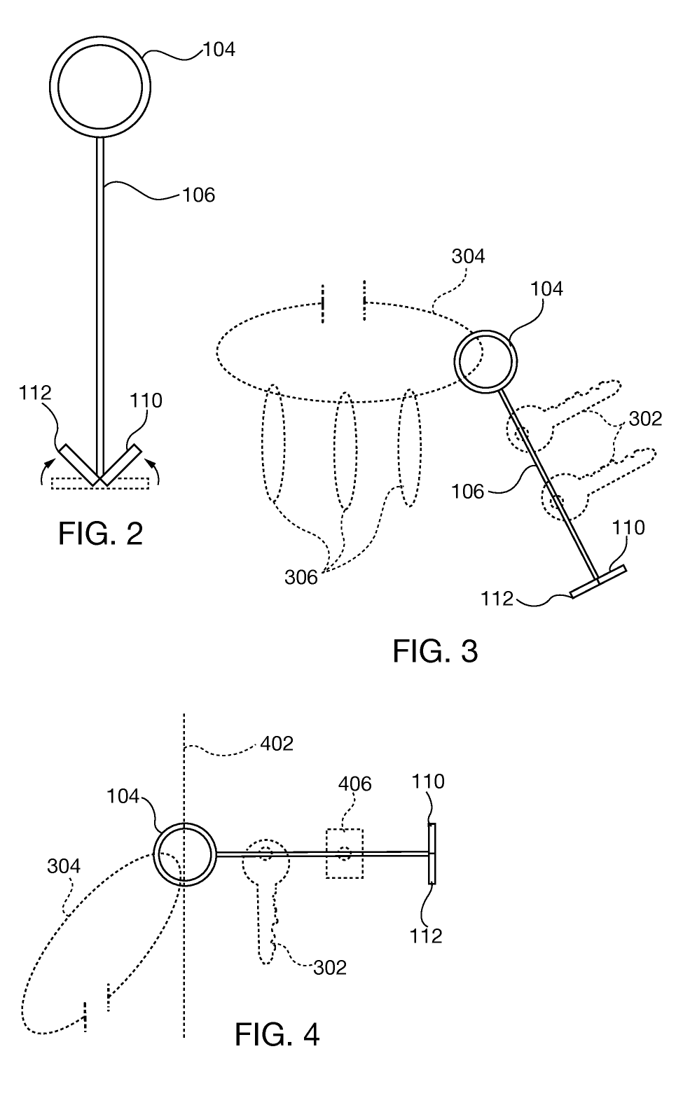

As seen in FIG. 2, in the second position, the user may manually deform the barriers 110 and 112. This may be accomplished by deforming the barriers 110 and 112 either in an upward or downward direction while squeezing the barriers 110 and 112. As a non-limiting example, this would allow the user to slide fishing weights 108 onto the longitudinal body 106. Once the first object is placed along the longitudinal body 106, then the barriers 110 and 112 may be release to hold the first object in place between the loop 104 and the longitudinal body 106.

As a non-limiting example, the user may use the attachment apparatus 102 to hold keys. In such an instance, the user would depress the barriers 110 and 112 to allow the hole in the key at the handle to slide along the longitudinal body 106. Once the key is place along the longitudinal body 106, the user would release the barriers 110 and 112 to allow it to form back into the original resting form. This would allow the barriers 110 and 112 to hold the keys between the loop 104 and barriers 110 and 112 along the longitudinal body 106.

As a non-limiting example, the second object may be a line. The line may be made up of polyurethane, nylon, plastic, or any other material. In addition it may be used in the activity of fishing wherein the line would be a fishing line. As a non-limiting example, if the attachment apparatus 102 is used for the purpose of fishing, then the line, here a fishing line may be threaded through the loop 104. Therefore, when used in this capacity, the user would deform the barriers 110 and 112 whereby allowing the user to slide the desired fishing weights 108 along the longitudinal body 106 and then release the barriers 110 and 112 to prevent the fishing weights 108 from falling off. Moreover, the user would thread the fishing line through the loop 104 to the desired length in order to weight the fishing line. An advantage of this system is that it allows for the quick change of fishing weights 108 without the need for the tying and untying of the fishing line from the weights 108 or cutting the fishing line altogether which would require the user to start from the beginning.

The barriers 110 and 112 are at a resting position at the first position. As such there is no tension and will stay in this position unless acted upon. In the deformed position the barriers 110 and 112 are in the second position and will be try to go back to the first position due to the resistance.

When the first object or the fishing weight 108 is attached to the attachment apparatus 102, it will require that the barriers 110 and 112 are in its deformed second position to allow the weights 108 to slide through. When the first object or weights 108 are prevented from falling off, the barriers 110 and 112 are in its first position or in its natural state.

As shown in FIG. 3, the second object may be a non-continuous ring 304. As a non-limiting example, it may also be a fishing line during the use of fishing for the purpose of weighing down the fishing line. Also as another non-limiting example, when it is used as a non-continuous ring 304, it may be linked to the loop 104. The non-continuous ring 304 may be made up of polyurethane, nylon, plastic, or any other material. The other material may be metal, polymer, or some material that is more rigid. Once it is linked to the loop 104, the non-continuous ring 304 may be used to hold weights 108, keys 302, or any other object. Moreover, the attachment apparatus 102 may attach the non-continuous ring 304 to another first object such as keys 302.

As seen in FIG. 4, the attachment apparatus 102 may have a line 402 threaded through. However, as a non-limiting example, the non-continuous ring 304 may be linked to the loop 104 concurrently with the line 402. Furthermore, the line 402 and the non-continuous ring 104 may be attached to the first object which may be keys 302 or widget 406 that is capable of being attached.

As seen in FIG. 2, a first object may be attached using an attachment device 102 by using a method. The attachment device 102 includes a longitudinal body 106. As a non-limiting example, the longitudinal body 106 may be made up of polyurethane, nylon, plastic, or any other material. The attachment device 102 also uses a loop 104. As a non-limiting example, the loop 104 may be made up of polyurethane, nylon, plastic, or any other material. The last part of the attachment device 102 includes a barrier 110 and 112. As a non-limiting example, the barrier 110 and 112 may be made up of polyurethane, nylon, plastic, or any other material.

In order to attach the first object to the second object, the user will deform the opposite flaps of the barrier 110 and 112. As seen in FIG. 2, the user will deform the flaps. As a non-limiting example, the user may manually squeeze the tabs in order to deform the flaps into the second position. Once that is accomplished, the user may slide the first object along the axis of the longitudinal body 106. Once the first object is placed along the longitudinal body 106, then the user may release the opposite flaps of the barrier 110 and 112 to its original first position which thereby prevents the first object from falling off the attachment device 102.

The flaps of the barrier 110 and 112 are in non-deformed first position will hold the first object along the axis of the longitudinal body 106. The first object has a bore that is smaller than the length of a barrier 110 and 112. As a non-limiting example, if key 302 are attached, then the bore of the key handle may be smaller than the length of the tabs of the barrier 110 and 112 thereby preventing the key 302 from falling off. If the tabs of the barrier 110 and 112 are in the deformed second position, the bore of the key 302 is larger than the tabs of the barrier 110 and 112 and would allow the key 302 to easily slide along the longitudinal body 106 on or off. The key 302 would be easily inserted along the longitudinal axis of the bore of the key 302 and once through, the user would release the barrier 110 and 112 thereby allowing the barrier 110 and 112 to snap back to the original non-deformed first position to retain the first object. As a non-limiting example, the first object may be sinker weights, keys, hang ropes, or chords.

The first object, as a non-limiting example may be sinker weights, key, hang ropes, or chords would attach to the second object. The second object may be a line 402 that may be threaded through the loop 104. Since the loop 104 may vary in sizes, so too can the line 402. The line 402 would thereby be attached to the first object by the use of the attachment apparatus 102.

The first object, as a non-limiting example, are weights 108 and it may be inserted through the barrier 110 and 112 when it is in the deformed second position. Once the barrier 110 and 112 is in its deformed second position, the bore of the weights 108 would be larger than the deformed second position barrier and would pass on through along the longitudinal body 106. Once the weight 108 is through, the barrier 110 and 112 would be released by the user and would snap back to the original non-deformed first position to hold the weight 108 in place because the length of the barrier 110 and 112 would be larger than the size of the bore of the weights 108.

The first object, as a non-limiting example, is a weight 108 would be slid along the longitudinal body 106 before the barrier 110 and 112 snaps back to the original non-deformed first position to retain the original first position and would retain the weights 108.

As shown in FIG.3 the attachment apparatus may be used in a different manner than the one described above. As a non-limiting example, here the non-continuous ring is threaded through the loop 104. Then an object 306 may be placed on the non-continuous ring 304. As a non-limiting example, the object 306 may be weights, keys, hang ropes, chords, or even additional attachment apparatuses 102. When additional attachment apparatuses 306 are attached to the non-continuous ring 304, this could also be used to add additional weights 108 or to provide a different fishing technique. At the same time, the user may add keys 302 to the original attachment apparatus 102 in order to create additional weight or could be used in a different context.

The attachment apparatus 102 may be used in everyday context. The user may attach keys 302 and then attach it to an object 306 such as other keys, wrist bands, or hooks. Moreover, the object 306 may be items of decoration such as lights, jewelry or even rubber bands.

As shown in FIG. 4, the line 402 may be tied to a backpack. This would allow the user to attach keys 302 or another trinket 406. The trinket may be something small as decorative beads or it could be something larger as a cell phone. The non-continuous ring 304 may be used to hold an identification badge or name tag.

In addition, the attachment apparatus 102 may be attached to itself. As a non-limiting example, the longitudinal body 106 could be bent which would allow the barrier 110 and 112 to pass through the loop 104 in its second deformed position. Once the barrier 110 and 112 have been inserted into the loop 104, the barrier 110 and 112 may be released to its original first position whereby preventing the longitudinal body 106 from straightening out and locking the attachment apparatus 102. As a non-limiting example, this may be used while weights 108 are located along the longitudinal body 106 and thereby hold them within the attachment apparatus 102. This use may be used to store the weights when not in use or to aid in transportation. In addition this method may be used to hold decorations. Depending on the size of the attachment apparatus 102, the device 102 may be slide along the wrist and have decorative beads locked in to be used as fashion.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

1. An attachment device for tethering a first object to a second object, the device comprising:
a single longitudinal body having a first end and a second end;
a loop at said first end; and
a barrier at said second end, wherein said barrier comprises two flaps and is deformable from a first position to a second position, wherein said flaps are perpendicular to said single longitudinal body in said first position, wherein said flaps are substantially parallel to said single longitudinal body in said second position, wherein said first object is retained between said loop and said barrier upon said single longitudinal body when said flaps are released back to said first position.

2. The attachment device of claim 1, wherein said second object is a line threaded through said loop.

3. (canceled)

4. (canceled)

5. (canceled)

6. The attachment device of claim 1, wherein said second object is a non-continuous ring, and wherein said ring may be linked to said loop.

7. The attachment device of claim 1, wherein said first object may be selected from the group consisting of sinker weights, keys, hang ropes, and chords.

8. A method for tethering a first object having a bore to a second object using an attachment device, said method comprising the steps of:
providing said attachment device, wherein the device includes a single longitudinal body, an axis, loop, and a barrier comprising two opposing flaps wherein the flaps are deformable from a first position to a second position, wherein said flaps are perpendicular to said single longitudinal body in said first position and substantially parallel to said single longitudinal body in said second position;
deforming said two opposite flaps of said barrier to said second position so as to fit through the bore of said first object;
sliding said first object over said deformed opposing flaps along the axis and onto said single longitudinal body; and
releasing said opposing flaps of said barrier back to said first position to prevent said first object from falling off said attachment device.

9. The method of claim 8, wherein said first object may be selected from the group consisting of sinker weights, keys, hang ropes, and chords.

10. The method of claim 8, further comprising the step of threading a line through said loop.
